(19) United States
(12) Patent Application Publication
(10) Pub. No.: US 2010/0162349 A1
(43) Pub. Date: Jun. 24, 2010

(54) CONTENT PROTECTION DEVICE, CONTENT PROTECTION METHOD, AND COMPUTER READABLE MEDIUM

(75) Inventor: Yoshikazu KAWAI, Tokyo (JP)

Correspondence Address: SUGHRUE-265550, 2100 PENNSYLVANIA AVE. NW, WASHINGTON, DC, 20037-3213, US

(73) Assignee: Fuji Xerox Co., Ltd., Tokyo (JP)

(21) Appl. No.: 12/476,869

(22) Filed: Jun. 2, 2009

(30) Foreign Application Priority Data
Dec. 19, 2008 (JP) 2008-323393

(51) Int. Cl. G06F 17/00; G06F 21/00

(52) U.S. Cl. 726/1; 726/26

(57) ABSTRACT

A content protection device includes: a use restriction definition information storage that stores one or more pieces of use restriction definition information in which at least use restriction conditions to restrict use of contents are defined; a comparison unit that monitors writing of an access log into an access log accumulation unit, and that when the access log is written into the access log accumulation unit, compares a use manner in which content specified by the access log is used and the use restriction conditions included in the use restriction definition information; and a restriction unit that if a result of the comparing by the comparison unit indicates that the use manner meets any of the use restriction conditions, restricts at least a same kind of use as the use manner.

### CROSS-REFERENCE TO RELATED APPLICATIONS

This application is based on and claims priority under 35 U.S.C. 119 from Japanese Patent Application No. 2008-323393 filed Dec. 19, 2008.

### BACKGROUND

1. Technical Field

The present invention relates to a content protection device, a content protection method, and a computer readable medium.

2. Related Art

In a DRM (Digital Rights Management) system for managing the security by setting a policy, a use situation of the content can be tracked and managed by an access log. If there is a clear access violation to the content, it is possible to compulsorily prohibit the access with a function of the system.

### SUMMARY

According to an aspect of the present invention, a content protection device includes: a use restriction definition information storage that stores one or more pieces of use restriction definition information in which at least use restriction conditions to restrict use of contents are defined; a comparison unit that monitors writing of an access log into an access log accumulation unit, and that when the access log is written into the access log accumulation unit, compares a use manner in which content specified by the access log is used and the use restriction conditions included in the use restriction definition information; and a restriction unit that if a result of the comparing by the comparison unit indicates that the use manner meets any of the use restriction conditions, restricts at least a same kind of use as the use manner.

### BRIEF DESCRIPTION OF THE DRAWINGS

Exemplary embodiment of the present invention will be described in detail based on the following figures, wherein:

FIG. 1 is a block diagram of a DRM server in a content protection device according to one embodiment of the present invention;

FIG. 2 is a hardware configuration diagram of a server computer forming the DRM server according to the embodiment 1;

FIG. 3 is a flowchart showing an automatic change process for policy according to the embodiment 1;

FIG. 4 is a view showing a setting content example of policy information after change according to the embodiment 1;

FIG. 5A is a view showing a setting example in which a policy is set for each group according to the embodiment 1;

FIG. 5B is a view showing a setting content example of policy information after the policy is changed from the set content of policy as shown in FIG. 5A;

FIG. 6 is a block diagram of the DRM server according to an embodiment 2;

FIG. 7 is a flowchart showing an automatic change process for policy according to the embodiment 2; and

FIG. 8 is a view showing a setting content example of the bind information after changing the setting according to the embodiment 2.

### DETAILED DESCRIPTION

The preferred embodiments of the present invention will be described below with reference to the drawings.

### Embodiment 1

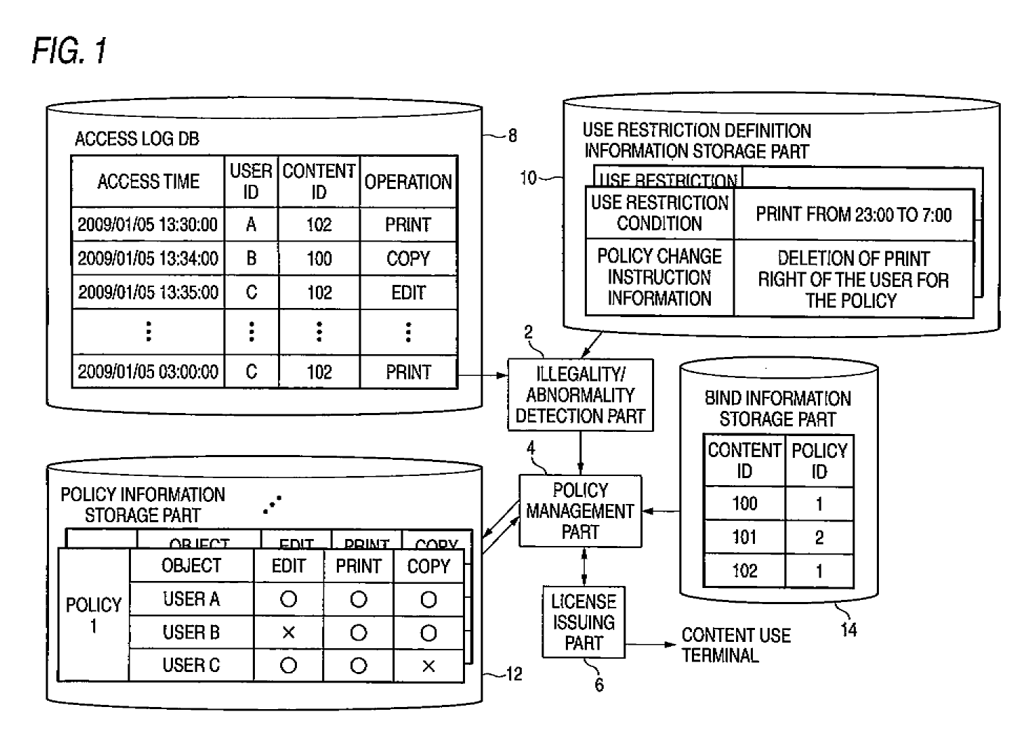

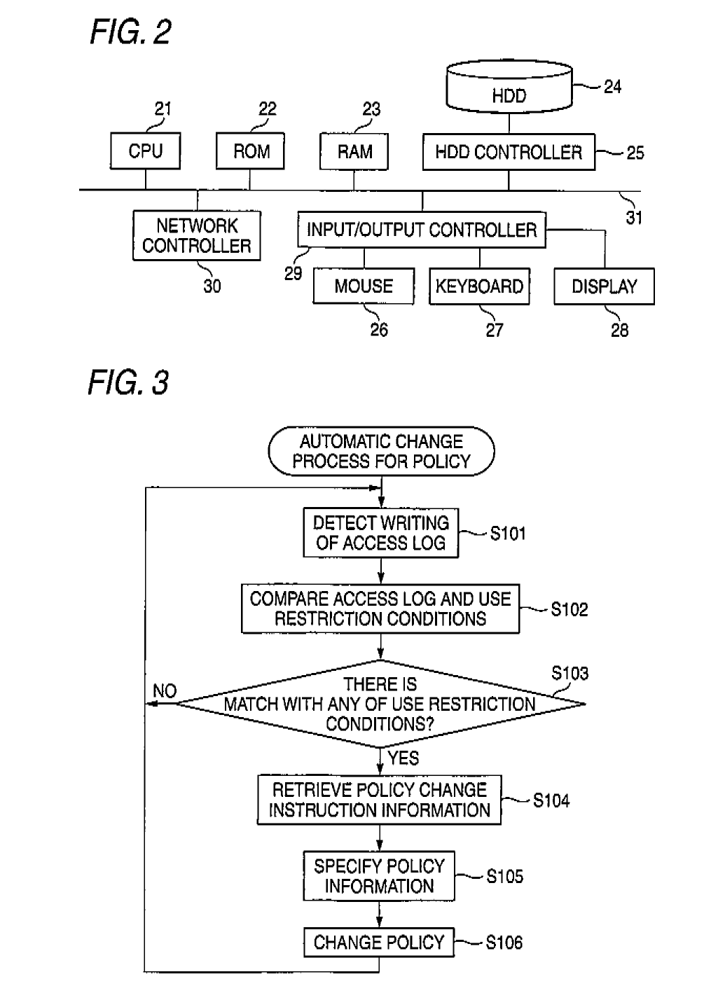

FIG. 1 is a block diagram of a DRM server in a content protection device according to one embodiment of the invention. Also, FIG. 2 is a hardware configuration diagram showing a server computer forming the DRM server according to this embodiment.

In FIG. 2, the server computer forming the DRM server can be realized by a general-purpose hardware configuration that exists conventionally. That is, the computer comprises a CPU 21, a ROM 22, a RAM 23, an HDD controller 25 connecting a hard disk drive (HDD) 24, an input/output controller 29 connecting a mouse 26 and a keyboard 27 provided as input means and a display 28 provided as a display device, and a network control 30 provided as communication means, which are connected to an internal bus 31, as shown in FIG. 2.

In FIG. 1, an illegality/abnormality detection part 2, a policy management part 4, a license issuing part 6, an access log database (DB) 8, a use restriction definition information storage part 10, a policy information storage part 12 and a bind information storage part 14 are illustrated. The illegality/abnormality detection part 2 monitors the writing of an access log into the access log database 8, and compares the use substance of the content specified by the access log with the use restriction conditions included in the use restriction definition information of the use restriction definition information storage part 10 when the access log is written into the access log database 8. And if the use substance specified by the access log is matched with any of the use restriction conditions, a policy change request to that effect is sent to the policy management part 4. Though the policy management part 4 is means for managing the policy stored in the policy information storage part 12, the policy management part 4 of this embodiment changes the setting substance of policy in accordance with the policy change request sent from the illegality/abnormality detection part 2. The license issuing part 6 issues a license in accordance with a license issuing request from the content use terminal.

In the access log database 8, the access log, including the “access time” when access to the content occurs, the “user ID” that is the identification information of the user who makes access, the “content ID” that is the identification information of the content, and the “operation” specifying the specific access substance to the content, are serially written and accumulated every time access to the content occurs. In FIG. 1, only the record items of the access log necessary for the explanation of this embodiment are shown. A collection function of the access log and the substance itself of the access log may accord with the prior art.

The use restriction definition information storage part 10 stores the use restriction definition information associating the “use restriction conditions” for restricting the use of the content, and the “policy change instruction information” defining the change substance of policy to restrict the use of the content if there is a match with the use restriction conditions. The manager sets the content use that possibly can not be indiscriminately assumed as the access violation from the achievements in the past to the “use restriction condition”. Further, the setting substance of policy to restrict the use if there is a match with the use restriction conditions is set to the “policy change instruction information”. The manager sets and registers one or more pieces of use restriction definition information generated in this way in the use restriction definition information storage part 10 before using the system.

The policy preset by the manager is registered in the policy information storage part 12. The policy information includes an “object” in which the identification information of the user or group who applies the policy is set, and whether or not the use substance of the content such as “edit”, “print” and “copy” is used by the user or group, corresponding to the policy ID specifying the policy. In FIG. 1, the presence of right is indicated by “∘” and the absence of right is indicated by “×”. The policy information as shown in FIG. 1 is only illustrative, and the setting substance may be the same as before.

In the bind information storage part 14, the bind information composed of a pair of the “content ID” for identifying the content and the “policy ID” of the policy set in the content is preset and stored as the content information.

Each of the components 2, 4 and 6 in the DRM server is realized in the cooperative operation between a computer forming the DRM server and a program operating on the CPU 21 mounted on the computer. Also, each of the storage means 8, 10, 12 and 14 is realized by the HDD 24 mounted on the DRM server.

Also, the program for use in this embodiment may be of course provided by communication means, but stored and provided in a computer readable recording medium such as a CD-ROM or DVD-ROM. The program provided by the communication means or from the recording medium is installed in the computer, and the CPU of the computer executes the installed program sequentially to implement various kinds of processes.

An automatic change process for policy according to this embodiment will be described below using to a flowchart as shown in FIG. 3. This process is performed by making the program for performing this processing function resident in the memory.

The illegality/abnormality detection part 2 always monitors the writing of the access log into the access log database 8. And if it is detected that the access log is written into the access log database 8 (step 101), the use substance of the content specified from the record substance in the access log and the use restriction conditions set in each use restriction definition information stored in the use restriction definition information storage part 10 are compared (step 102). Herein, if the use substance of the content is unmatched with any of the use restriction conditions (N at step 103), the operation returns to the process for monitoring the access log in the illegality/abnormality detection part 2 (step 101). If the use substance of the content is matched with any of the use restriction conditions (Y at step 103), the policy change instruction information corresponding to the matched use restriction condition is taken out of the use restriction definition information storage part 10 (step 104). In a setting example as shown in FIG. 1, the printing of the content ID “102” performed at three o'clock by the user C corresponds to the “printing from 23:00 to 7:00”. Though the use substance of the content may correspond to a plurality of use restriction conditions in some cases, the user restriction definition information may be ordered according to the registration sequence, or the items of access log matched with the use restriction conditions may be ordered to select one use restriction definition information. In this way, if the use of the content matched with the use restriction definition information is detected, the illegality/abnormality detection part 2 sends a policy change request including the taken-out policy change instruction information and the setting substance of the applicable access log to the policy management part 4.

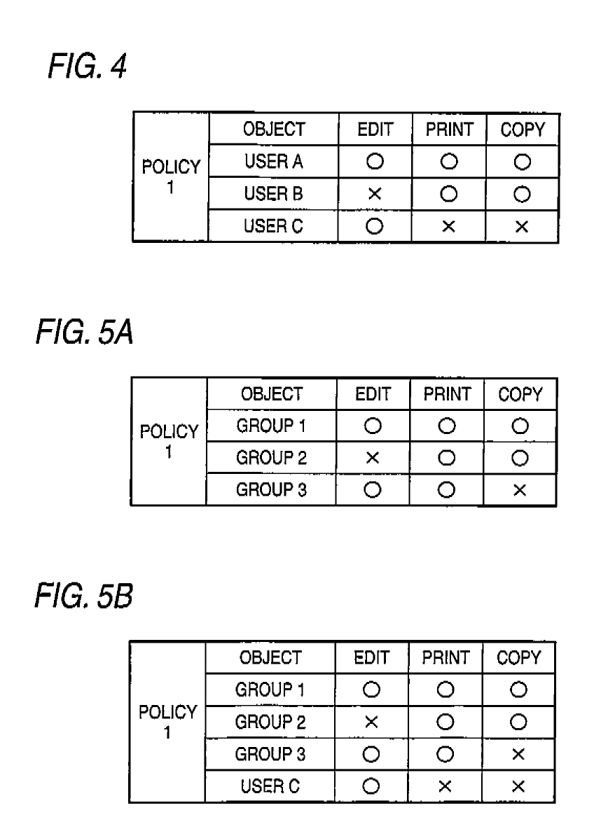

If the policy change request is sent from the illegality/abnormality detection part 2, the policy management part 4 searches the bind information storage part 14 with the content ID included in the policy change request as the key to specify the policy ID of the policy set in the content, and searches the policy information storage part 12 with the specified policy ID as the key to specify the policy information of change object (step 105). Subsequently, the policy management part 4 changes the setting substance of the policy specified from the user ID included in the policy change request among the specified policy information in accordance with the policy change instruction information included in the policy change request (step 106). In the setting example as shown in FIG. 1, since the policy change instruction with the substance of the “deleting the print right of the user for the policy” is set, the policy management part 4 changes the print right of the user C to the absence of right “×”. An example of the setting substance of the policy information after change is shown in FIG. 4.

In the above way, if the content of printing at three o'clock midnight is used by the user C in which the access violation or not is unclear, the print right of the user C is changed to the absence of right at once when the use is detected in this embodiment.

It is supposed that the user C thereafter makes a request of issuing the license to the DRM server to print the content of the content ID “102” again. This issuing request includes at least the user ID of the requestor, an indication of the print operation and the content ID of the content of print object. The license issuing part 6, upon receiving the issuing request sent from the content use terminal used by the user C, passes the request substance to the policy management part 4 to inquire for the presence or absence of right. The policy management part 4 searches the bind information storage part 14 to specify the policy ID from the content ID included in the passed request substance, and further specify the policy information specified by the policy ID to check the presence or absence of right. As a result, there is no print right of the user C for the policy 1 corresponding to the content of the content ID “102”, as will be clear from the setting example after change in FIG. 4. Hence, the license issuing part 6 issues a license without the print right to the license issuing request from the user C. That is, the user C can not print the content of the content “102”. If this print is not an unfair practice, the user C may contact the manager separately to make a request for giving the print right.

By the way, it is supposed that the policy is set for not each individual but each group. This setting example is shown in FIG. 5A. Also, it is supposed that the user C belongs to the group 3 only. That is, it is supposed that only the policy set for the group 3 is effective as the policy for the user C. In this case, when the user C makes the access (printing the content ID “102” at three o'clock) as previously described, other users belonging to the group 3 also can not print the content in which the policy 1 is set, if the print right for the policy set in the group 3 is changed to the absence. Thus, if the setting of policy is changed for only the user belonging to the group, the policy management part 4 does not change the policy of the group 3 to which the user C belongs, but changes the policy of the user C by newly generating the policy of the user C, as exemplified in FIG. 5B. The policy set for the user C is specifically generated by copying the policy of the group 3 and changing the print right to restrict the access to the absence. In this embodiment, the policy set for each user is given priority over the policy set for the group.

As described above, the access restriction is made in accordance with the settings of the use restriction definition information in this embodiment. The access restriction as referred to herein means basically deleting only the access right (print right) for restricting the use of the same kind, namely, the print, in the access right given to the user, upon detecting for the certain user the print that can not be indiscriminately assumed as the access violation, as exemplified in this embodiment. However, the deletion of the print right is made depending on the setting substance of the policy change instruction information. That is, the access right for other than the detected use may be restricted at the same time, depending on the settings of the policy change instruction information. For example, the edit right in addition to the print right may be deleted from the authority of the user C. Or the other access right may be instead restricted. In this way, what restriction to impose depends on the setting substance of the policy change instruction information. The access right can be extended depending on the settings of the policy change instruction information. Accordingly, a check function of the setting substance of the policy change instruction information may be provided to restrict the access right.

### Embodiment 2

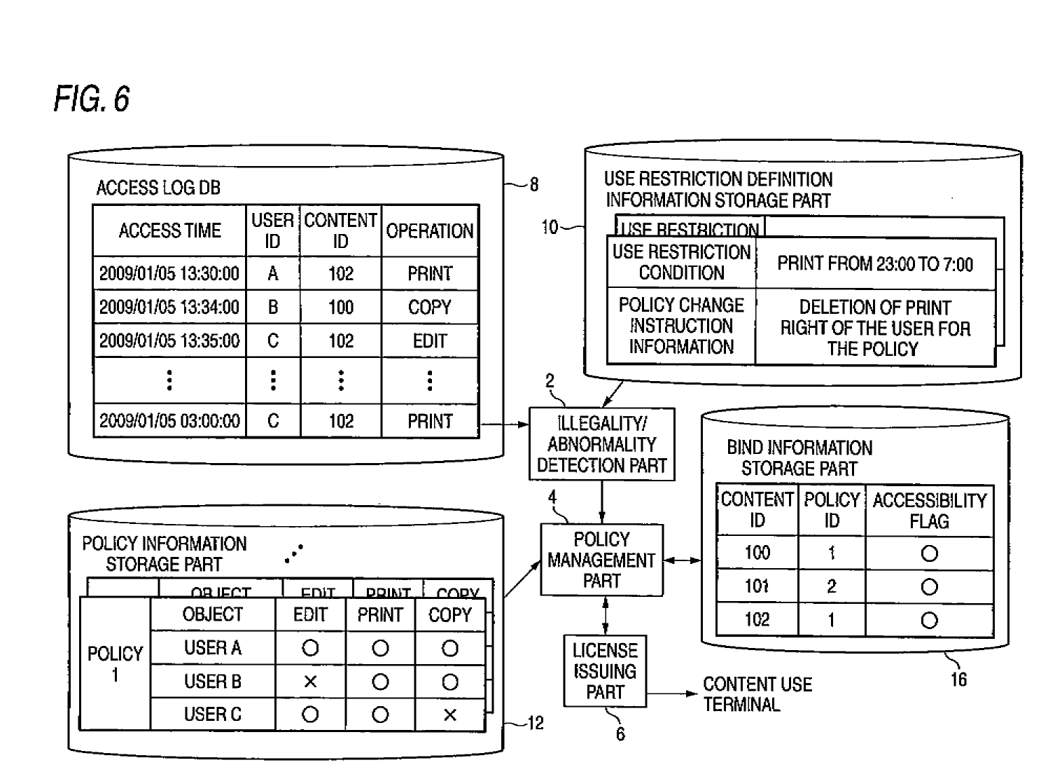

FIG. 6 is a block diagram of the DRM server according to an embodiment 2. The same or like parts are designated by the same reference numerals as shown in FIG. 1 in the embodiment 1. In this embodiment, the information set in a bind information storage part 16 is different from the embodiment 1. That is, the bind information is preset by further associating the accessibility information of setting whether or not access to the content is possible, in addition to the content ID and the policy ID as in the embodiment 1. In FIG. 6, the access possible is indicated by “∘”, and the access impossible is indicated “×”. The hardware configuration of this embodiment may be the same as in the embodiment 1.

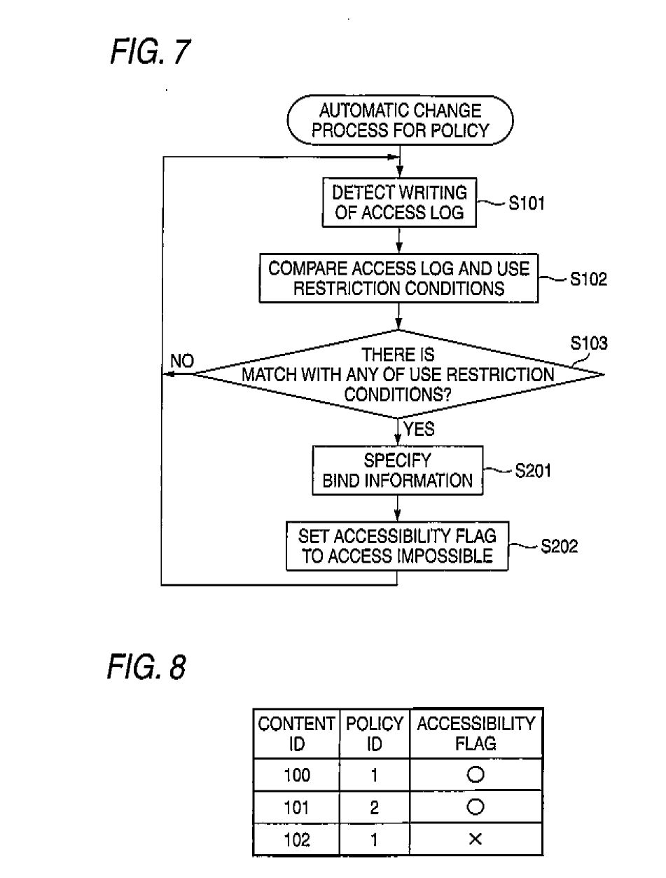

An automatic change process for policy according to this embodiment will be described below using to a flowchart as shown in FIG. 7. This process is performed by making the program for performing this processing function resident in the memory. Also, the same steps are denoted by the same step numbers as in the embodiment 1, and their explanation is properly omitted.

If it is detected that the access log is written into the access log database 8 (step 101), the illegality/abnormality detection part 2 compares the use substance of the content specified from the record substance in the access log and the use restriction conditions set in each use restriction definition information stored in the use restriction definition information storage part 10 (step 102). As a result, if the use substance of the content is matched with any of the use restriction conditions (Y at step 103), a policy change request including the setting substance of the applicable access log is sent to the policy management part 4.

If the policy change request is sent from the illegality/abnormality detection part 2, the policy management part 4 searches the bind information storage part 16 with the content ID included in the policy change request as the key to specify the bind information corresponding to the content ID (step 201). And the corresponding accessibility flag is set to the access impossible “×” (step 202). FIG. 8 shows a setting substance example of the bind information after changing the setting. In this embodiment, the policy information is not changed.

In the above way, if the content of printing at three o'clock midnight is used by the user C in which the access violation or not is unclear, access to the content of use object is prohibited when the use is detected in this embodiment. That is, though the access is restricted for each user and each use substance (operation) to delete the print right of the user C in the embodiment 1, access is prohibited for each content of use object in this embodiment.

It is supposed that the user C thereafter makes a request of issuing the license to the DRM server to print the content of the content ID “102” again. The license issuing part 6, upon receiving the issuing request sent from the content use terminal used by the user C, passes the request substance to the policy management part 4 to inquire for the presence or absence of right. The policy management part 4 searches the bind information storage part 16 to check the setting substance of the accessibility flag corresponding to the content ID included in the passed request substance. Herein, if the accessibility flag is set to the access impossible as in this example, the policy management part 4 returns the absence of right to the issuing request to the license issuing part 6. As a result, the license issuing part G does not issue the license in response to the license issuing request from the user C. That is, the user C can not print the content of the content ID “102”. Further, in this embodiment, access to the content of the content ID “102” is prohibited for the other users. The user who wants to resume the access to this content is necessary to make contact with the manager separately.

Though the access to the content is prohibited for each content and therefore restricted for the other users in this embodiment, it is unnecessary to change the settings of the policy information. Accordingly, it is required that at least the use restriction conditions are set in the use restriction definition information, but the policy change instruction information may not be necessarily set.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. A content protection device comprising:
a use restriction definition information storage that stores one or more pieces of use restriction definition information in which at least use restriction conditions to restrict use of contents are defined;
a comparison unit that monitors writing of an access log into an access log accumulation unit, and that when the access log is written into the access log accumulation unit, compares a use manner in which content specified by the access log is used and the use restriction conditions included in the use restriction definition information; and
a restriction unit that if a result of the comparing by the comparison unit indicates that the use manner meets any of the use restriction conditions, restricts at least a same kind of use as the use manner.

2. The content protection device as claimed in claim 1,
wherein
the use restriction definition information storage further stores use stop information in which each of the use restriction conditions and corresponding policy change instruction information defining that if each use restriction condition is met, what a policy to restrict the use of the contents is changed to are associated with each other, and
if the result of the comparing by comparison unit indicates that the use manner meets any of the use restriction conditions, the restriction unit changes a policy in accordance with the policy change instruction information corresponding to the met use restriction condition.

3. The content protection device as claimed in claim 2,
wherein
the restriction unit changes the policy for a user by newly generating a policy for the user and applying the generated policy to the user, if only a policy set in a group to which the user belongs is effective as the policy for the user specified by the access log.

4. The content protection device as claimed in claim 2, further comprising
a content information storage that stores, for each content, content information associating identification information of the content, specific information of a policy set for the content, and accessibility information for setting accessibility to the content,
wherein
if the use content specified by the access log is met with any of the use restriction conditions, the restriction unit sets information indicating that access to the content is prohibited in the accessibility information corresponding to the content specified from the access log.

5. A content protection method comprising;
storing one or more pieces of use restriction definition information in which at least use restriction conditions to restrict use of contents are defined;
monitoring writing of an access log, and when the access log is written, comparing a use manner in which content specified by the access log is used and the use restriction conditions included in the use restriction definition information; and
if a result of the comparing by the comparison unit indicates that the use manner meets any of the use restriction conditions, restricting at least a same kind of use as the use manner.

6. A computer readable medium storing a program causing a computer to execute a process for restricting use of contents, the process comprising:
storing one or more pieces of use restriction definition information in which at least use restriction conditions to restrict the use of the contents are defined;
monitoring writing of an access log, and when the access log is written, comparing a use manner in which content specified by the access log is used and the use restriction conditions included in the use restriction definition information; and
if a result of the comparing by the comparison unit indicates that the use manner meets any of the use restriction conditions, restricting at least a same kind of use as the use manner.
